(19) United States
(12) Patent Application Publication
(10) Pub. No.: US 2006/0165471 A1
(43) Pub. Date: Jul. 27, 2006

(54) Casing for bar-shaped cosmetic products

(76) Inventor: Antonio Fernandez Fernandez, Torrejon de Ardoz (ES)

Correspondence Address: YOUNG & THOMPSON, 745 SOUTH 23RD STREET, 2ND FLOOR, ARLINGTON, VA, 22202, US

(21) Appl. No.: 11/039,856

(22) Filed: Jan. 24, 2005

(51) Int. Cl. B43K 23/00; B43K 19/00

(52) U.S. Cl. 401/88; 401/49

(57) ABSTRACT

Casing for bar-shaped cosmetic products, such as lipstick bar container casings, obtained from a base of polyolefins, polycarbonates, styrenes, polyvinyl chlorides, polyacrylics, polyoxymethylenes, nylons, thermoplastic saturated polyesters, or polyphenylene oxide. The plastic product selected from any of those mentioned above is included in the casing mixed wit fibreglass, which improves the rigidity, dimensional stability, and mechanics of the various parts that maku up the casing.

### PURPOSE OF THE INVENTION

This invention refers to a casing of the type used for selling bar-shaped cosmetic products, specifically, those commonly known as lipsticks.

The purpose of the invention is to obtain a casing that, without increasing the size and without increasing the amount of material that is used to produce the casing, but rather with a notable reduction of this second aspect, substantially improves its rigidity, dimensional stability, and mechanics.

Another purpose of the invention is to minimise the friction coefficient between parts, when necessary, and even microbiologically protect the lipstick bar contained inside the casing when this is also considered convenient.

### BACKGROUND OF THE INVENTION

Although there are some casings of the type mentioned above that contain some metal components, most often those casings are composed of plastic material; furthermore, lipstick casings are normally composed of a base body that contains a device for the axial movement of a slide part that supports the lipstick bar, housed in a shell and protected by a cover that is coaxially coupled to the base, normally by seal-coupling, so that if there are any metal elements within the casing, it tends to be the cover that is of this type of material.

The plastic materials used in this type of casing have been, for a long time, the same as those used in other industrial areas of plastic part injection, such as different types of containers, and more specifically, said products are polystyrenes and their copolymers, polyvinyl chloride and its derivatives, nylons, polyoxymethylenes, polyacrylics, saturated polyesters, polycarbonates, etc.

These plastic materials are known on the market under the acronyms: PP, PE, COC, PC, PS, SB, SAN, ABS, ASA, PVC, PMMA, POM, PA, PET, PBT, PPE, etc.

The choice of one plastic product or another from those indicated above depends on various conditions, such as, price, supply, type of part to be obtained, etc., but all of them have a common denominator; the need for the parts obtained using these products to contain a wall that is thick enough so that the mechanics of the casing, as well as its structural rigidity, are appropriate. Nevertheless, on several occasions problems arise due to the lack of dimensional stability, which, in turn, negatively affects the mechanics; in turn, it is desirable that the rigidity be increased without increasing the thickness of the parts.

### DESCRIPTION OF THE INVENTION

The casing for bar-shaped cosmetic products that is proposed by the invention resolves, in a completely satisfactory manner, the aforementioned problem, without increasing in the least the thickness of the parts making up the casing so that its rigidity, dimensional stability, and mechanics are appreciably increased.

For this purpose, more specifically and using as base raw material any of the conventional products used in this industrial field, such as polyolefins, polycarbonates, styrenes, polyvinyl chlorides, polyacrylics, polyoxymethylenes, nylons, thermoplastic saturated polyesters, or polyphenylene oxide, the invention consists in mixing any of these materials with fibreglass so that with this mixture the aforementioned advantages or features are obtained.

The amount of fibreglass incorporated into the plastic material, specifically to the driver, the slider part, and/or the shell of the casing can vary according to the desired results in each case; the percentage of fibreglass used in the mixture should preferably be of a value close to 10%.

In the specific case of parts that require mechanical improvement in terms of minimising their friction coefficient, the base plastic material used, of the type mentioned above, will incorporate a polytetrafluo-rethylene (PTFE) or high molecular weight polyethylene (UHMWPE). These products are particularly appropriate for mixing with polyoxymethylenes, nylons, and thermoplastic saturated polyesters, and can be used in the mixture at an amount of approximately 10% for obtaining the driver, the slider part, and/or shell of the casing.

When microbiological protection is also desired for the lipstick bar contained in the casing, basic plastic materials can be used to obtain the shell, such as polyolefins, styrenes, polyvinyl chlorides, or polyacrylics, by incorporating an additive from the “trichlor-hydroxi-diphenyl-ether” family, at a ratio of approximately 2%.

In those cases where the barrier effect of the casing needs to be improved in terms impermeability of the seal, in order to obtain the base and the driver of the casing, the base materials to be used will be styrenes or polyolefins, with a polyvinylidene (PVDF) or silane mixture at a ratio of approximately 3%.

### EXAMPLE OF PRACTICAL EMBODIMENTS OF THE INVENTION

### Example 1

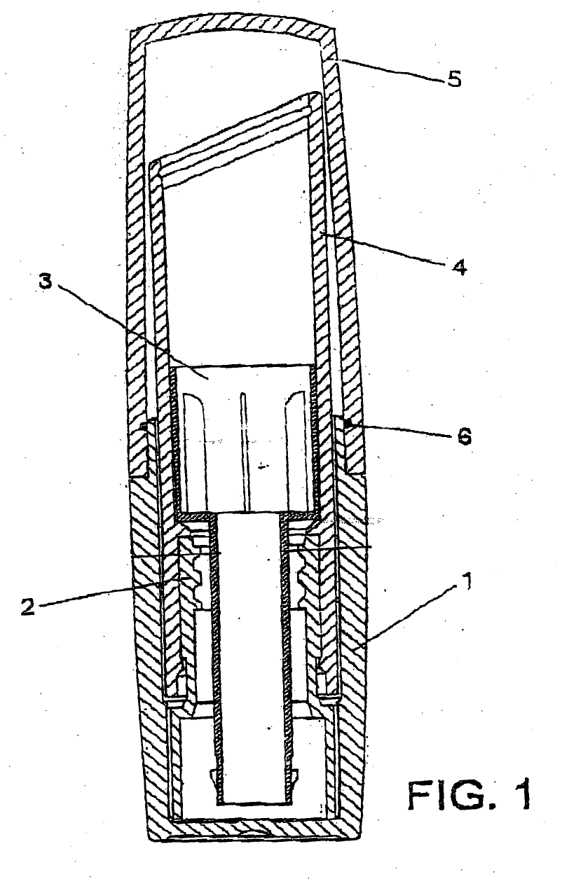

To create a lipstick casing like the one represented in FIG. 1, a styrene was used for styrene parts (1), (5), and (4), specifically ABS, and a polyoxymethylene, specifically POM, was used for parts (2) and (3), at a ratio of 90%, to which fibreglass was added at a ratio of the remaining 10%.

With these raw materials, specific parts of the casing were obtained, specifically the base (1), the driver (2), the slider part (3), and the shell (4). With the cover (5), a sealed closure is obtained on the base (1). A notable increase was observed in the structural rigidity of each individual part, as well as of the entire casing, better dimensional stability, and improved mechanics.

### Example 2

As raw materials for obtaining the parts of the casing represented in FIG. 1, a nylon was used, specifically, PA, at a ratio of 80%, to which 10% of PTFE (polytetrafluo-rethylene) was added, and then fibreglass was added, at a ratio of the remaining 10%.

In the parts obtained, greater structural rigidity was observed, as well as a notable increase in dimensional stability, and improved mechanics. Additionally, there was substantial improvement in the friction properties of said parts.

### Example 3

To obtain the parts of the casing in FIG. 1, the raw material used was nylon, specifically PE, at a ratio of 88%; as an additive, a trichlor-hydroxi-diphenyl-ether was added, specifically a Ciba Irgaguard B1000 additive at a ratio of 2%, and fibreglass at a ratio of the remaining 20%; it was observed that the parts obtained, in addition to increasing rigidity, dimensional stability, and improving mechanics, also improved the microbiological protection aspect.

### Example 4

To obtain the parts of the casing represented in FIG. 1, the raw materials used for the base (1) and cover (5) was a styrene, specifically ABS, at a ratio of 87%, to which polyvinylidene (PVDF) was added at a ratio of 3%, and lastly, fibreglass was added at a ratio of the remaining 10%. It was observed that the parts, in addition to increasing rigidity, dimensional stability, and improving mechanics, also improved the barrier properties of the casing; that is, the sealing of the casing.

1. Casing for bar-shaped cosmetic products, such as lipstick bar container casings, obtained from a base of polyolefins, polycarbonates, styrenes, polyvinyl chlorides, polyacrylics, polyoxymethylenes, nylons, thermoplastic saturated polyesters, or polyphenylene oxide, characterised in that the plastic product selected from any of those mentioned above is included in the casing mixed with fibreglass, which improves the rigidity, dimensional stability, and mechanics of the various parts that make up the casing.

2. Casing for bar-shaped cosmetic products according to claim 1, characterized in that the plastic material is used in said parts at a ratio of approximately 90%, whilst the fiberglass is used at a ration of approximately 10%.

3. Casing for bar-shaped cosmetic products according to claim 1, characterized in that when the friction properties of the parts are to be improved, the base plastic materials used are polyoxymethylenes, nylons, or thermo-plastic saturated polyesters and, in addition to fibreglass, the casing parts incorporate a polytetrafluo-rethylene (PTFE) or a polyethylene of a high molecular weight (UHMWPE), which is included in the mixture at a quantity of approximately 10%, at the expense of a corresponding reduction in the polyoxymethylenes, nylons, or thermoplastic saturated polyesters.

4. Casing for bar-shaped cosmetic products according to claim 2, characterized in that when there is to be microbiological protection, for the casing parts the following basic plastic materials are used: polyolefins, styrenes, polyvinyl chlorides, or polyacrylics and, in addition to fibreglass, additives from the “trichlor-hydroxi-diphenyl-ether” family are used at a ratio of approximately 2%, at the expense of a corresponding reduction in polyolefins, styrenes, polyvinyl chlorides, or polyacrylics.

5. Casing for bar-shaped cosmetic products according to claim 2, characterized in that when the barrier effect of the casing is to be increased in terms of impermeability of the seal, the casing contains styrenes or polyolefins, said fibreglass, and polyvinylidene (PVDF) or silane, the latter at a ratio of approximately 3% at the expense of a corresponding reduction in the styrene or polyolefin.
